(19) United States
(12) Patent Application Publication
(10) Pub. No.: US 2009/0080581 A1
(43) Pub. Date: Mar. 26, 2009

(54) TIME SEQUENTIAL PROCESSING OPERATIONS

(75) Inventors: Axel Schuur, Mountain View, CA (US); Ann P. Shen, Saratoga, CA (US); Ali Tabatabaei, San Francisco, CA (US)

Correspondence Address: FISH & RICHARDSON P.C., P.O. BOX 1022, MINNEAPOLIS, MN, 55440-1022, US

(73) Assignee: NanoAmp Solutions Inc. (Cayman), Santa Clara, CA (US)

(21) Appl. No.: 12/236,342

(22) Filed: Sep. 23, 2008

Related U.S. Application Data
(60) Provisional application No. 60/974,914, filed on Sep. 25, 2007.

(51) Int. Cl. H04B 1/10

(52) U.S. Cl. 375/350; 375/354

(57) ABSTRACT

At least some of the arithmetic operations of a filter or other digital process can be performed time sequentially, which may allow the arithmetic elements for the filter or other digital process to be used multiple times for multiple operations.

### CROSS REFERENCE TO RELATED APPLICATIONS

This application claims the benefit of priority from U.S. Provisional Application entitled “Hybrid Channel Filter,” Application No. 60/974,914 filed Sep. 25, 2007, the disclosure of which is incorporated by reference.

### TECHNICAL FIELD

This disclosure relates to signal processing and filtering in, for example, decimation and channel filtering as used in communication system receivers.

### BACKGROUND

In many integrated receiver systems, filtering of incoming signals is provided in the analog domain. After filtering, the signal can then be converted to the digital domain through use of an analog-to-digital converter (ADC) such as a large dynamic range, sigma-delta Analog-to-digital converter (SD-ADC). Thereafter, digital circuits can provide decimation filtering and channel filtering to obtain desired signals. Examples of techniques for digital filtering are Infinite Impulse Response (IIR) filters and Finite Impulse Response (FIR) Filters. In IIR filters, the output response to an impulse signal at the input is generally not bounded in time, while in an FIR filter the output response is generally bounded in time.

### SUMMARY

In general, some implementations feature a method of performing digital filtering that includes filter arithmetic operations. The method includes generating a system clock, in which the system clock has a rate of at least twice an input data rate. The method includes providing the system clock to a control circuit that controls at least one multiplier, at least one adder, and at least one storage element such that at least some of the filter arithmetic operations are performed time sequentially by the at least one multiplier, the at least one adder, and the at least one storage element before receiving a next input sample.

These and other implementations can optionally include one or more of the following features. The digital filtering can be represented by the function:

$$y [ n ] = {\sum }_{i = 0}^{L} c [ i ] * x [ n - i ] + {\sum }_{j = 1}^{M} d [ j ] * y [ n - j ]$$

In the digital filtering representation, x[n] can represent an array of sampled input signals; y[n] can represent an array of filter output signals; c can represent an array of input filter coefficients, d can represent an array of output filter coefficients; n can represent an input sampling number; and L and M can represent positive integers. At least some of the filter arithmetic operations that are performed time sequentially by the at lest one multiplier, the at lest one adder, and the at lest one storage element before receiving a next input sample can include at least the following operations performed time sequentially: (1) multiplying at least one delayed input sample by a first input filter coefficient to generate a first multiplication result, adding the first multiplication result to a first previously accumulated sum to generate a current accumulated sum; and storing the current accumulated sum; (2) multiplying the current input sample by a second input filter coefficient to generate a second multiplication result; adding the second multiplication result to the current accumulated sum to generate an accumulated input sum, and storing the accumulated input sum; (3) multiplying at least one delayed output sample by an output filter coefficient to generate a third multiplication result, adding the third multiplication result to a second previously accumulated sum to generate a current accumulated output sum, and storing the current accumulated output sum; and (4) summing the accumulated input sum and the accumulated output sum to generate an output. The digital filtering can include an IIR filter. The digital filtering can include a FIR filter. The digital filtering can include feed-forward and feedback loops. An integer part of a ratio of the system clock to the input data rate can be equal to or larger than a total number of the filter arithmetic operations that are performed time sequentially. The system clock can be an analog-to-digital conversion sampling clock. A maximum number of the filter arithmetic operations that are performed time sequentially can be limited to the integer part of the ratio of the system clock to the input data rate. The values of the input and output filter coefficients can be fixed or variable. The input and output filter coefficients can be stored in a table or calculated dynamically. A filter coefficient selector can select the input and output filter coefficients. The filter coefficient selector can include a counter, logic circuit, an arithmetic unit (ALU), or a programmable controller. The control circuit can be configured to control two or more multipliers, two or more adders, two or more multiplexers, and at least one accumulator. The input and output filter coefficients can be time-sequentially coupled to an input of the at least one multiplier. The current input sample, the delayed input sample and the delayed output sample can be time-sequentially coupled to an input of the at least one multiplier. The digital filtering can be represented by:

$$y [ n ] = e * \{ {\sum }_{j = 0}^{2} d [ j ] {\sum }_{i = 0}^{3} c [ i ] * x [ n - i - j ] \} + {\sum }_{j = 1}^{2} g [ j ] {\sum }_{i = 0}^{3} c [ i ] * x [ n - i - j ] .$$

In the digital filtering representation, x[n] can represent an array of sampled input signals; y[n] can represent an array of filter output signals; e can represent a constant; c, d and g can represent arrays of filter coefficients, n can represent an input sampling number; and i and j can represent positive integers. The control circuit can be configured to control the at least one multiplier, the at least one adder, and the at least one storage element such that at least one of the multiplier, the adder, or the storage element is reused for the filter arithmetic operations that are performed time sequentially.

In general, some implementations feature a circuit implementing a digital filter. The circuit implementing the digital filter includes: a system clock generator configured to generate a system clock having a rate at least twice an input data rate; at least one multiplier; at least one adder; at least one storage element; and a control circuit. The control circuit is configured to control the at lest one multiplier, the at lest one adder, and the at lest one storage element. The system clock is coupled to the control circuit such that at least some of the filter arithmetic operations are performed time sequentially by the at least one multiplier, the at least one adder, and the at least one storage element before receiving a next input sample.

These and other implementations can optionally include one or more of the following features. The digital filter can be represented by the function:

$$y [ n ] = {\sum }_{i = 0}^{L} c [ i ] * x [ n - i ] + {\sum }_{j = 1}^{M} d [ j ] * y [ n - j ] ,$$

in which x[n] can represent an array of sampled input signals; y[n] can represent an array of filter output signals; c can represent an array of input filter coefficients, d can represent an array of output filter coefficients; n can represent an input sampling number; and L and M are positive integers. The system clock can be coupled to the control circuit such that at least the following operations can be performed time sequentially by the multiplier, the adder, and the storage element before receiving a next input sample: (1) multiplying at least one delayed input sample by a first input filter coefficient to generate a first multiplication result, adding the first multiplication result to a first previously accumulated sum to generate a current accumulated sum; and storing the current accumulated sum; (2) multiplying the current input sample by a second input filter coefficient to generate a second multiplication result; adding the second multiplication result to the current accumulated sum to generate an accumulated input sum, and storing the accumulated input sum; (3) multiplying at least one delayed output sample by an output filter coefficient to generate a third multiplication result, adding the third multiplication result to a second previously accumulated sum to generate a current accumulated output sum, and storing the current accumulated output sum; and (4) summing the accumulated input sum and the accumulated output sum to generate an output. The filter can include an IIR filter. The filter can include a FIR filter. The digital filter can include feed-forward and feedback loops. The circuit can include two or more multipliers, two or more adders, three or more multiplexers and at least one accumulator. An integer part of a ratio of the system clock to the input data rate can be equal to or larger than a total number of the filter arithmetic operations that are performed time sequentially. The system clock can be an analog-to-digital conversion sampling clock. A maximum number of the filter arithmetic operations that are performed time sequentially can be limited to the integer part of the ratio of the system clock to the input data rate. Values of the input and output filter coefficients can be fixed or variable. The input and output filter coefficients can be stored in a table or calculated dynamically. The circuit can include a filter coefficient selector to select the input and output filter coefficients. The filter coefficient selector can include a counter, a logic circuit, an ALU or a programmable controller. The input and output filter coefficients can be time-sequentially coupled to an input of the at least one multiplier. The current input sample, the delayed input sample and the delayed output sample can be time-sequentially coupled to an input of the at least one multiplier. The filter can be represented by:

$$y [ n ] = e * \{ {\sum }_{j = 0}^{2} d [ j ] {\sum }_{i = 0}^{3} c [ i ] * x [ n - i - j ] \} + {\sum }_{j = 1}^{2} g [ j ] {\sum }_{i = 0}^{3} c [ i ] * x [ n - i - j ] .$$

In the filter representation, x[n] can represent an array of sampled input signals; y[n] can represent an array of filter output signals; e can represent a constant; c, d and g can represent arrays of filter coefficients, n can represent an input sampling number; and i and j can represent positive integers. The control circuit can be configured to control the multiplier, the adder, and the storage element such that at least one of the multiplier, the adder, or the storage element can be reused for the filter arithmetic operations that are performed time sequentially

In general, some implementations feature a decimation and channel filtering system. The decimation and channel filtering system includes a decimator configured to receive an input signal at a system clock rate and output a decimated signal on a decimator output, in which the decimator is configured to output the decimated signal at a filter input data rate that is at least twice slower than the system clock rate. The system includes a first programmable gain amplifier coupled to the decimator output, and a first filter coupled to an output of the first programmable gain amplifier. The first filter is configured to perform at least some filter arithmetic operations time sequentially based on the system clock rate. The system includes a second programmable gain amplifier coupled to an output of the first filter, a numeric mixer coupled to an output of the second programmable gain amplifier, a numeric local oscillator coupled to the numeric mixer, and a second filter coupled to an output of the numeric mixer. The second filter is configured to perform at least some filter arithmetic operations time sequentially based on the system clock rate. The system includes a third programmable gain amplifier coupled to an output of the second filter.

These and other implementations can optionally include one or more of the following features. The numeric local oscillator can be configured to perform at least some oscillator arithmetic operations time sequentially based on the system clock rate. The system can include a filter coefficient selector configured to select a filter coefficient of an array of filter coefficients for the filter arithmetic operations of the first or second filter. The first or second filter can include an IIR filter. The first or the second filter can include forward and/or feedback loops. The first or second filter can include calculation components, storage elements, delay elements, and/or multiplexers. The array of filter coefficients can include decimation filter coefficients, the filter input coefficients, delayed filter input coefficients, and delayed filter output coefficients. A maximum number of filter arithmetic operations performed time sequentially by the first and the second filter can be limited to an integer part of a ratio of the system clock to the filter input data rate. The decimation filter, the mixer, the first filter, and the second filter can be configured to reuse components.

In general, some implementations feature a receiver. The receiver includes a radio frequency (RF) input signal received by an antenna coupled to an RF filter, an low noise amplifier (LNA) coupled to an output of the RF filter, a first set of I/Q mixers configured to perform image rejection and mix an output of the LNA with a first set of quadrature I/Q output signals tuned by a first frequency divider from an output of a first local oscillator, and a set of I/Q intermediate frequency (IF) filters coupled to a first set of mixed I/Q outputs of the first set of I/Q mixers. The receiver includes a second set of I/Q mixers configured to mix filtered I/Q outputs of the I/Q intermediate filer (IF) filters with a second set of I/Q outputs generated and tuned by a second frequency divider from an output of a second local oscillator, an analog-to-digital converter coupled to a second set of mixed I/Q outputs and configured to produce a digital signal sampled at a system clock, and a digital-signal-processing unit including a decimator. The digital-signal-processing unit including the decimator is configured to receive the digital signal and generate a decimated output at a data rate slower than the system clock, a first filter, a mixer, a third local oscillator, and a second filter, in which at least one of the decimator, the first filter, the mixer, the third local oscillator, or the second filter is configured to perform at least some arithmetic operations time sequentially based on the system clock rate. The receiver includes a baseband processing circuit configured to receive an output from the digital-signal-processing unit.

These and other implementations can optionally include one or more of the following features. The receiver can include a filter coefficient selector to select filter coefficients. The filter coefficient selector can include a counter, a logic circuit, an ALU or a programmable controller. Each of the decimator, the first filter, the mixer, the third local oscillator, or the second filter can be configured to perform at least some arithmetic operations time sequentially based on the system clock rate. A maximum total number of arithmetic operations can be performed sequentially by the decimator, the first filter, the mixer, the third local oscillator, and the second filter, either individually or in combination, can be limited to an integer part of a ratio of the system clock to a data rate that is slower than the system clock.

Details of one or more implementations are set forth in the accompanying drawings and description herein. Other features, aspects, and advantages will be apparent from the description, the drawings, and the claims.

### DESCRIPTION OF THE DRAWINGS

FIG. 1 is a block diagram of an example of a filtering process for decimation and channel filtering.

FIGS. 2A-2B are schematics of examples of infinite impulse response filter architectures.

FIGS. 3A-3B are examples of pseudo-code for an infinite impulse response filter.

FIGS. 4A-4C are examples of circuit schematics for infinite impulse response filters.

FIG. 5 is a schematic of an example of a low-intermediate-frequency (low IF) receiver.

FIG. 6 is a schematic of an example of a direct-conversion receiver.

### DETAILED DESCRIPTION

A filtering or other digital process can be implemented using flip-flops, registers, or other storage elements to store incoming data and intermediate results and a control circuit to schedule calculations. In various implementations, segments of the filter can be customized to allow for the necessary field-programmability through use of programmable arithmetic elements between filter functions. Alternatively, or additionally, coefficients can be selected from different hardwired sets using control signals. Thus, in some implementations, a filter or other digital process can employ selectable sets of hard-wired coefficients, re-use of arithmetic and/or storage elements, and a control circuit (e.g., a state machine) for scheduling calculations. In various implementations, the level of configurability and reuse of arithmetic and storage elements can be customized for each stage of the filter or other digital processing to achieve minimum required area. In some implementations, the filter or other digital process can process data at a sample rate that is less than the available clocking rate of the system. Because the system can have a higher available clocking rate, the arithmetic elements can be used multiple times for multiple operations in the system, while the filter or other digital process can still be operated in the system at a lower sample rate.

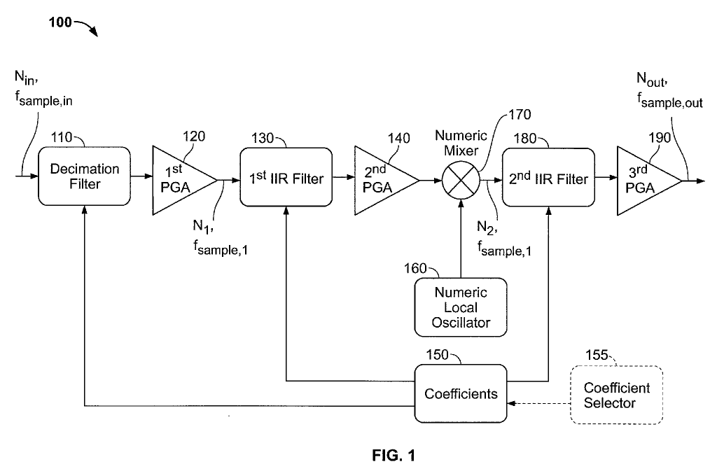

FIG. 1 is a block diagram of a filtering process 100 for decimation and channel filtering. The filtering process 100 includes a first decimation filter 110, a first programmable gain amplifier (PGA) 120, a first IIR filter 130, a second PGA 140, a numeric mixer 170 using a numeric local oscillator signal 160, a second IIR filter 180, and a third PGA 190. The decimation filter 110 and IIR filters 130 and 180 are configured by coefficients 150, which can be controlled by a coefficient selector 155.

In various implementations, the first decimation filter 110 can provide for a first reduction in sample rate together with filtering to avoid signal aliasing. Also, the number of bits per sample can be increased from the value of Nᵢₙ at the input to a higher number. The first PGA 120 can implement a first programmable gain stage. The first IIR filter 130 can provide first channel filtering to remove unwanted interfering signals. Due to this filtering, the dynamic range of the signal can be reduced, and this can enable greater gain to be provided by the second PGA 140.

The described filtering process 100 can be used in a low intermediate frequency (low IF) receiver. In various implementations, a second down conversion stage can be implemented in the digital circuit using the numeric mixer 170. After the mixer 170, a second IIR filter 180 can provide for further channel filtering and equalization of the signal. With further reduction of dynamic range, more programmable gain can be added in the third PGA 190.

In FIG. 1, the sampling frequency of the input, f_{sample,in} can be higher than the sampling frequency of an intermediate signal, e.g., f_{sample,1}. As such, a clock frequency large enough to sample at a rate of f_{sample,in} can have extra clock cycles when compared to filter input rate f_{sample,1}. These excess clock cycles can allow parallel operations to be broken down into time sequential operations, which may allow for the reuse of circuit storage and calculation components in conjunction with selectable coefficients without increasing the requirements of the circuit clock speed. As a simplified example, if f_{sample,in}=3 Hz and f_{sample,1}=1 Hz, a component for f_{sample,1} requiring 2 multiplications could use a single multiplier instead of two multipliers. In particular, the first clock cycle can cause the multiplier to perform the first multiplication with a given coefficient, the second clock cycle can cycle selection of coefficients for the multiplier to a second coefficient, and the third clock cycle can cause the multiplier to perform the second multiplication with the second coefficient.

The filtering process 100 illustrates several components that can use the time sequential operations. In particular, various components of the filtering process 100 can use one or more sets of storage elements, delay elements, and one or more sets of coefficients 150 for calculations. More particularly, in various implementations, the first and second IIR filters 130 and 180, the decimation filter 110 and the numeric mixer 170 can reuse storage elements to store incoming data, intermediate results, and state machines to schedule calculations using the coefficients 150. As such, the filtering process 100 may not require hardwired sets of coefficients for each calculation in the filter.

The coefficient selector 155 can be used to select particular coefficients or sets of coefficients for a given calculation. The coefficient selector 155 can be a logic-based switching circuit for simple control/switching of coefficients or sets of coefficients. For example, in one implementation, a counting circuit is used to count through multiple coefficients in a sequence. In implementations requiring more complicated or dynamic control, the coefficient selector 155 can incorporate an ALU or other types of processing devices rather than hard-wired logic circuitry.

Also, the coefficient selector 155 can be dedicated to a specific component (e.g., within the second IIR filter 180) or can select particular coefficients for use with each of multiple components (e.g., within both the first and second IIR filters 130 and 180). As shown, the filtering process 100 includes a single coefficient selector 155, though, various implementations can include a coefficient selector 155 dedicated to each of one or more components using the coefficients 150.

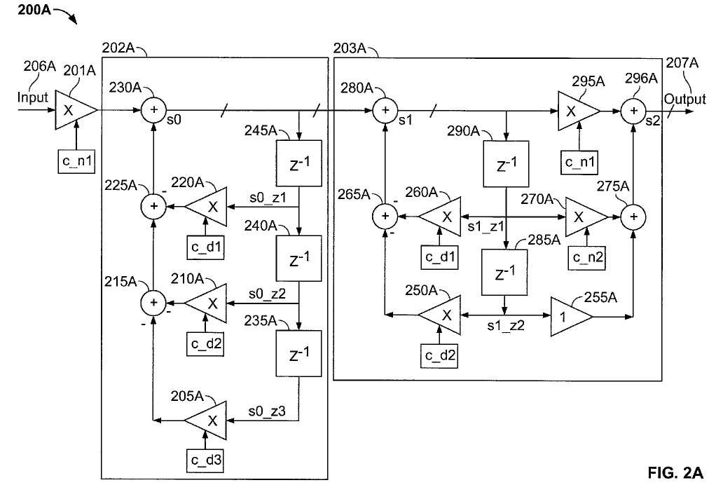

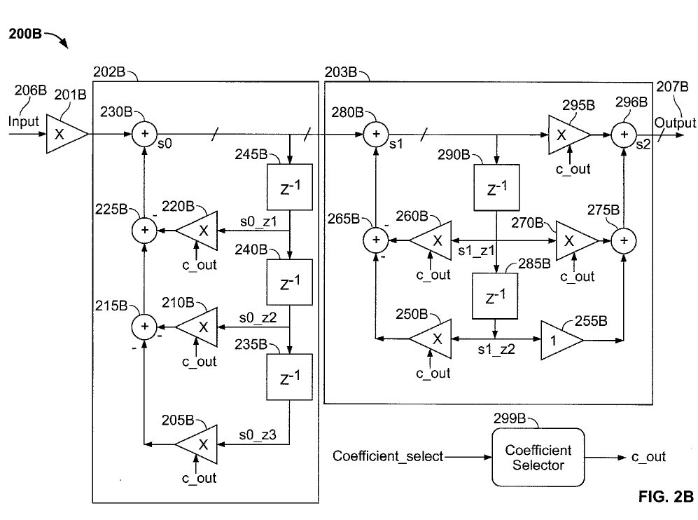

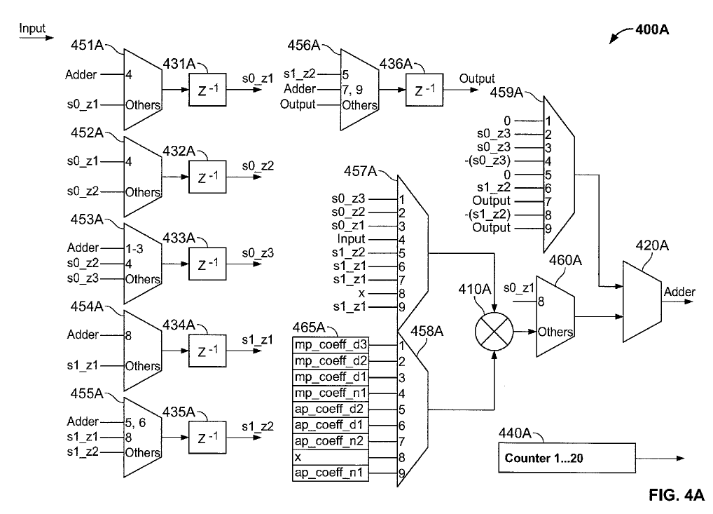

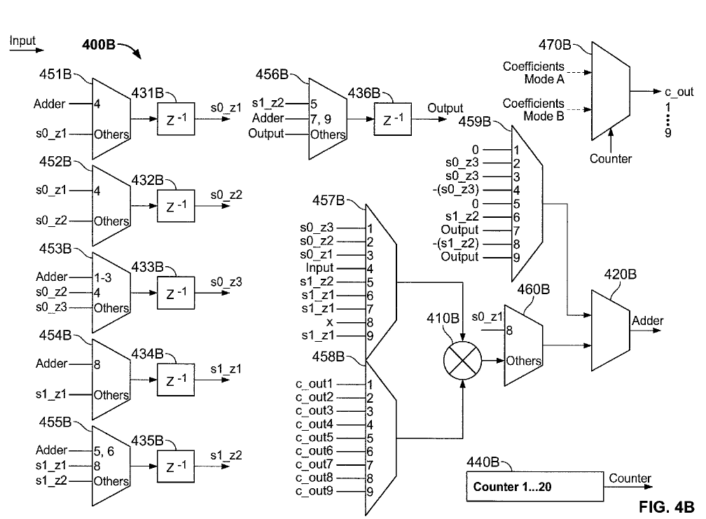

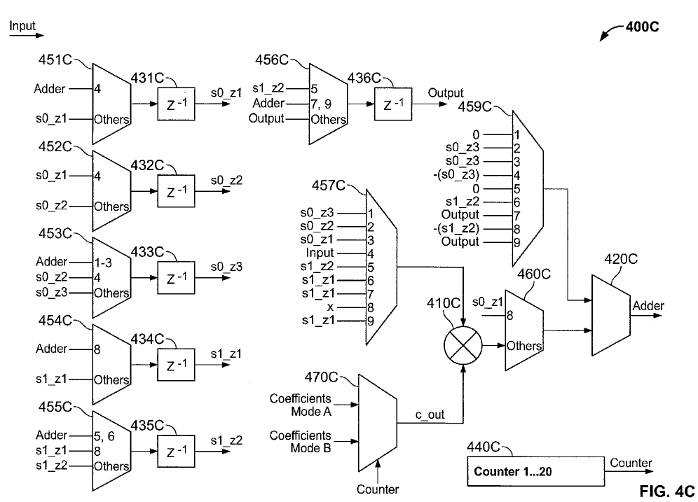

FIGS. 2A-2B are schematics of IIR filter architectures 200A-200B. In various implementations, the IIR filter architectures 200A-200B can be used to implement the IIR filters 130 and/or 180. The following describes implementations of architectures 200A and 200B in which calculation components, storage elements as well as other components such as delay elements and multiplexers are selectively reused, which may allow for reduced chip area, power and cost but provide needed programmability. The techniques can also be applied to FIR filters, which are a special case of the IIR filter. Some implementations are shown and described with respect to FIGS. 4A-4C.

The output of an IIR filter can be a function of an input and previous inputs and outputs:

$$y [ n ] = {\sum }_{i = 0}^{L} c [ i ] * x [ n - i ] + {\sum }_{j = 1}^{M} d [ j ] * y [ n - j ]$$

where y[n] is the output, x[n] is the input, y[n−j] and x[n−i] are previous outputs and inputs, respectively, and n is an input sample number. c[i] and d[j] are filter coefficients and L and M are integers. For an FIR, the output can be a function of the previous inputs with no feedback from the previous outputs. The above equation describes an FIR filter if all the coefficients d[j] are zero.

In general, the calculations to implement the above filter equation can be translated into pseudo code with time sequential operations that are performed by the appropriate components in response to a clock rate that is higher than the data rate of the filter input signal. For instance, in one implementation, the system clock is provided to one or more multipliers, one or more adders, and one or more storage elements so that each multiplication and addition in the input sample portion of the above equation is performed time sequentially, each multiplication and addition in the output sample portion of the above equation is performed time sequentially, and then the total of both portions are added to produce the output.

In other implementations, a filter algorithm based on the above described filter equation with feed-forward and feedback loops is translated into pseudo-codes with both parallel operations and serial (time sequential) operations. Calculation components, storage elements, delay elements, and other components can then be designed according to the pseudo-code operations to optimize the time sequential operations for component reuse and area, power and cost reduction.

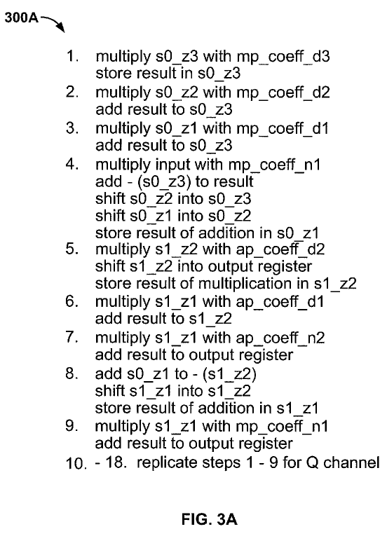

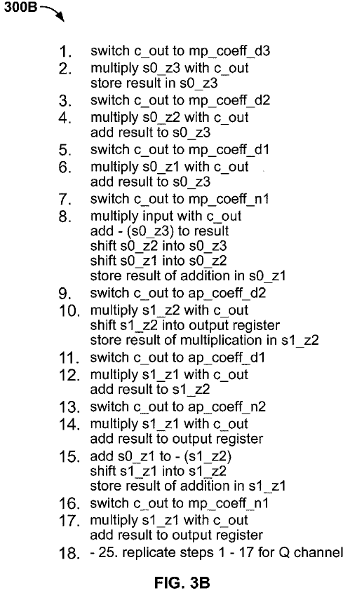

Examples of filter architectures are used in the following description for ease of understanding of the time sequential operation techniques. In particular, FIGS. 2A and 2B show flow charts of examples of digital filter architectures with feed-forward and feedback loops for small values of the integers L and M. FIGS. 3A-3B and 4A-4C are pseudo-codes and schematics using time sequential operations to implement the filter architectures shown in FIGS. 2A and 2B.

FIG. 2A depicts an IIR 200A that uses dedicated coefficients with multipliers, and FIG. 2B depicts an IIR 200B that uses selectable coefficients with multipliers. Various implementations can include different components or configure the components differently. In general, the filter architectures 200A and 200B include feedforward and feedback loops, and the output y[n] is represented by nested summation equations

$$y [ n ] = e * \{ {\sum }_{j = 0}^{2} d [ j ] {\sum }_{i = 0}^{3} c [ i ] * x [ n - i - j ] \} + {\sum }_{j = 1}^{2} g [ j ] {\sum }_{i = 0}^{3} c [ i ] * x [ n - i - j ] .$$

where x[n] is an array of sampled input signals; y[n] is an array of filter output signals; e is a constant; c, d and g are arrays of filter coefficients, n is an input sampling number; and i and j are positive integers.

Referring to FIG. 2A, a straightforward implementation of the IIR filter architecture 200A includes 8 multipliers, 7 adders, and 5 register storage elements so that calculations can be performed in parallel. Also, the IIR filter 200A includes dedicated coefficients associated with the multipliers. The first feedback loop 202A on the left side of FIG. 2A can use feedback loops while the second feedback loop 203A on the right side of FIG. 2A can use both feedback and feed-forward loops. The values of the coefficients, the number of storage elements, and the number of bits for each storage element and each coefficient can all be varied according to the requirements of the IIR filter 200A.

In a straightforward implementation of the IIR filter architecture 200A, the signal s0_z3 in feedback loop 202A is multiplied with a multiplier 205A using coefficient c_d3 and the resulting signal is stored at a storage element s0_z3. The signal s0_z2 is multiplied with a multiplier 210A using coefficient c_d2. The resulting signals of the multipliers 205A and 210A are added using an adder 215A. The signal s0_z1 is multiplied with a multiplier 220A using coefficient c_d1. The resulting signals of the adder 215A and the multiplier 220A are added using an adder 225A. The input signal 206A is multiplied with a multiplier 201A using coefficient c_n1. The resulting signals of the multiplier 201A and the adder 225A are added using an adder 230A. The signal s0_z2 is shifted with the shift register 235A into the signal s0_z3. The signal s0_z1 is shifted with a shift register 240A into the signal s0_z2. The resulting signal s0 of the adder 230A is stored in a shift register 245A.

Further, in the second feedback loop 203A, the signal s1_z2 is multiplied with a multiplier 250A using coefficient c_d2. The signal s1_z2 is shifted into a unit multiplier (multiplying by 1) 255A. The resulting signal of the unit multiplier 255A is stored at a storage element s1_z2. The signal s1_z1 is multiplied with a multiplier 260A using coefficient c_d1. The resulting signals of multipliers 250A and 260A are added with an adder 265A. The signal s1_z1 is multiplied with a multiplier 270A using coefficient c_n2. The resulting signal of the multiplier 270A is added to an output of the unit multiplier 255A using an adder 275A. The resulting signals of the adder 230A and the adder 265A are added using an adder 280A. The signal s1_z1 is shifted using a shift register 285A into the signal s1_z2. The resulting signal of the adder 280A is stored in a shift register 290A. The resulting signal of the shift register 280A is multiplied with a multiplier 295A using coefficient c_n1. The resulting signals of the multiplier 295A and the adder 275A are added using an adder 296A to form the output signal s2 207A. The above description is an example, and other different filter coefficients can be used in the second feedback/feed-forward loop 203A. However, the more redundant coefficients there are, the less hardware are required.

Referring to FIG. 2B, the IIR filter architecture 200B is an example of another IIR filter architecture that has selectable coefficients. In various implementations, the IIR filter 200B architecture can be used to implement the IIR filter 130 and/or 180.

A straightforward implementation of the IIR filter architecture 200B uses 8 multipliers, 7 adders, and 5 register storage elements so that calculations can be performed in parallel. Also, the IIR filter 200B includes a coefficient selector 299B. The coefficient selector 299B can use multiple outputs such that some or all of the multipliers are coupled to a unique output of the coefficient selector 299B. The values of the coefficients, the number of storage elements, and the number of bits for each storage element and the coefficient selector 299B can all be varied according to the requirements of the IIR filter 200B.

The coefficient selector 299B includes a separate output c_out1-c_out7 that is coupled to each of the multipliers of the IIR filter 200B, by varying the coefficient outputs on c_out1-c_out7, the coefficient for each of the multipliers are varied as well. In various implementations, the coefficient selector 299B is configured using, for example, logic circuitry, to output (as c_out) the coefficients c_d1, c_d2, c_d3, c_n1, and c_n2 shown in FIG. 2A to the respective components the coefficients are dedicated to in the IIR filter 200A of FIG. 2A.

In a straightforward implementation of the IIR filter architecture 200B, the signal s0_z3 in feedback loop 202B is multiplied with a multiplier 205B using a coefficient c_out and the resulting signal is stored at a storage element s0_z3. The signal s0_z2 is multiplied with a multiplier 210A using the coefficient c_out. The resulting signals of the multipliers 205B and 210B are added using an adder 215B. The signal s0_z1 is multiplied with a multiplier 220B using the coefficient c_out. The resulting signals of the adder 215B and the multiplier 220B are added using an adder 225B. The input signal 206B is multiplied with a multiplier 201B using coefficient c_out. The resulting signals of the multiplier 201B and the adder 225B are added using an adder 230B. The signal s0_z2 is shifted with the shift register 235B into the signal s0_z3. The signal s0_z1 is shifted with a shift register 240B into the signal s0_z2.

Further, in a second feedback loop 203B, the signal s1_z2 is multiplied with a multiplier 250B using coefficient c_out. The signal s1_z2 is shifted into a unit multiplier 255B. The resulting signal of the unit multiplier 255B is stored at a storage element s1_z2. The signal s1_z1 is multiplied with a multiplier 260B using coefficient c_out. The resulting signals of multipliers 250B and 260B are added with an adder 265B. The signal s1_z1 is multiplied with a multiplier 270B using coefficient c_out. The resulting signals of the multiplier 270B and the unit multiplier 255B are added using an adder 275B. The resulting signals of the adder 230B and the adder 265B are added using an adder 280B. The signal s1_z1 is shifted using a shift register 285B into the signal s1_z2. The resulting signal of the adder 280B is stored in a shift register 290B. The resulting signal of the shift register 280B is multiplied with a multiplier 295B using coefficient c_out. The resulting signals of the multiplier 295B and the adder 275B are added using an adder 296B to form the output signal s2 207B.

The different frequency requirements of the filtering process 100 of FIG. 1 illustrate how sequential operations can be used to reduce the number of calculation components, such as, for example, reducing the several multipliers of the IIR filter 200A of FIG. 2A to a single multiplier 410A. In particular, in reference to the IIR filter 180 of FIG. 1, the parallel operations conducted at f_{sample,1} can be broken down into sequential operations conducted at f_{sample,in} while maintaining the signal data rate of f_{sample,1}. In one example implementation, the incoming signal sample rate f_{sample,in} may be 100 Msamples/s, and accordingly, the system clock can be provided at 100 MHz. After decimation filtering, the sample rate can be reduced to f_{sample,1}=5 Msamples/s. The second IIR filter 180, operating at a rate of 5 Msamples/s, can either perform all arithmetic operations in parallel, using a clock of 5 MHz, or can perform up to 20 operations sequentially using a clock of 100 MHz. In various implementations that take advantage of the 100 MHz clock frequency required by the f_{sample,in}, the number of calculation components (e.g., multipliers) can be reduced by reusing components over multiple clock cycles. FIGS. 3A and 3B and FIGS. 4A-4C illustrate this reduction of circuit components.

Specifically, FIGS. 3A and 3B illustrate examples of pseudo-code 300A and 300B for implementing the IIR filter architecturs 200A and 200B, respectively. FIGS. 4A and 4B are schematics 400A and 400B of IIR filters implemented based on the pseudo-codes 300A and 300B. The pseudo-codes 300A and 300B and schematics 400A and 400B represent example implementations of the IIR filter architecturs 200A and 200B in which parallel filter operations occurring at a lower clock frequency are broken into time sequential operations at a higher clock frequency.

Each pseudo code includes multiple steps (e.g., pseudo code 200A includes 9 steps for one channel) with one or more operations performed at each step. The steps in the pseudo-codes described by 300A-300B are performed time sequentially at a higher clock rate f_{clk} than the input signal data rate of f_{sample,1}. The operations in each step can be performed in parallel or serial, depending on the ratio of f_{clk} to f_{sample,1}.

An example of a clock of frequency f_{clk} can be a system clock of rate f_{sample,in}. The serial steps (and operations when performed serially) of the pseudo-codes 3A-3B can be performed time sequentially with reusable components to reduce the hardware required. Each step in the pseudo-codes of 3A-3B includes operations to be completed before the next input signal at the data rate of f_{sample,1} arrives. The larger a ratio R_{clk} of f_{clk} to f_{sample,1}, the more extra cycles of f_{clk} can be used for time sequential operations, which may allow operations within each step to be performed serially. In general, R_{clk} is greater than or equal to two. The maximum number of time sequential operations, including operations within each step, depends on the integer value of the ratio R_{clk} and may be limited based on this ratio. In some applications, R_{clk} is large enough to have extra cycles of f_{clk} still left after the component reduction is optimized with serial operations.

The operations within each step of the pseudo-codes 300A-300B can be parallel operations and therefore processed concurrently at the clock rate of f_{clk}. However, parallel operations can require duplicated hardware components for the operations if they are the same type of operation, e.g. multiplication.

Referring to FIG. 4A, the schematic 400A illustrates an implementation of sequential operations allowing for the reduction of required calculation components coupled with dedicated, but selectable coefficients 465A. The schematic 400A can be used to implement, for example, the circuit components of the IIR filter architecture 200A of FIG. 2A or other filters.

In the schematic 400A, a multiplier 410A, an adder 420A, six storage registers 431-436A, a counter 440A, and signal multiplexers 451A-460A are included. As compared to parallel implementations of the IIR filters architectures 200A and 200B of FIGS. 2A and 2B, only one adder and one multiplier are included. For example, the single multiplier 410A can be reused so as to implement some or all of the multipliers included in a parallel implementation of the IIR filter architecture 200A. Also, the existing storage registers 431A-436A can be reused for storing intermediate results throughout the computations rather than providing a general read/write memory to store data and results. This reuse of storage elements can be conducted by using the counter 440A to count, with the excess clock cycles, through a sequence of calculations and storages for the components. For example, in various implementations, the multiplier 410A can be used for steps 1-7 and 9 of the pseudo-codes 300A and 300B of FIGS. 3A and 3B.

The multiplexer 458A is coupled to dedicated coefficients 465A to be used in calculations. As such, more complex circuiting such as a coefficient-set multiplexer 470B (described below), or other logic circuitry such as an ALU, is not required to select the proper set of coefficients to be the input to the multiplexer 458A. Rather, the value on the counter 440A can cause the multiplexer to pass through the input tied to the appropriate fixed coefficient.

In general, the counter 440A can provide timing of state machine functionality and can schedule the calculations and operations. The counter value can select the state of the signal multiplexers 451A-460A thereby selecting one of their input signals. Also, as described above, the counter value can select the appropriate one of the fixed coefficients 465A through multiplexer 458A. Therefore, the signal that is connected to the multiplier 410A, the adder 420A, and to the storage registers 431A-460A can change depending on the value of the counter 440A. The counter 440A can change its value with each cycle of the system clock which may have a frequency of f_{clk}.

When f_{clk} is greater than f_{sample,1}, the number of required calculation components (e.g., multiplier, adder, etc.) can be reduced by using the extra clock cycles of f_{clk} to control the selection and reuse of the calculation components. In the example of FIG. 1, the sample rate of the signal to be processed is f_{sample,1}, and a maximum number of integer(f_{clk}/f_{sample,1}) operations can be processed sequentially before the next sample of the input signal is provided. Also, with reference to the IIR filter architecture 200A, the number of required storage registers can be reduced as a result of using the storage registers 431A-436A to store one or more of delayed versions of the input signal to the first feedback loop 202A (labeled s0_z1, s0_z2, s0_z3), delayed versions of the input to the second feedback loop 203A (labeled s1_z1, s1_z2), and/or intermediate results of the arithmetic processing (labeled adder). This functionality of the storage registers can be controlled by the signal multiplexers 451A-460A together with the counter 440A.

In various implementations, the counter 440A can be replaced with an ALU or another sophisticated processing device to dynamically control the hardware elements and coefficients. Moreover, with more dynamic control, the required number of circuit components or complexity can be reduced by reuse of inputs. For example, the number of inputs to the multiplexers 457A and 458A can be reduced. Such a reduction can also enable further reduction of required components with a given ratio of f_{sample,in} to f_{sample,1}.

Referring to FIG. 4B, the schematic 400B illustrates an implementation of time sequential operations allowing for the reduction of required calculation components coupled with adjustable coefficients. The schematic 400B can be used to implement the circuit components of the IIR filter architecture 200B or other filters. In the schematic 400B, a multiplier 410B, an adder 420B, six storage registers 431B-436B, a counter 440B, signal multiplexers 451B-460B, and the coefficient-set multiplexer 470B are included.

In contrast to the dedicated, but selectable coefficients 465A coupled to the multiplexer 458A of FIG. 4A, the multiplexer 458B is coupled to outputs of the coefficient-set multiplexer 470B to provide for selectable sets of coefficients. The coefficient-set multiplexer 470B has dynamic outputs, which can reflect one of multiple sets of coefficients. Referring to the filtering process 100 of FIG. 1, the coefficient-set multiplexer 470B can be used to implement the coefficients 150 and/or coefficient selector 155. As such, outputs of the coefficient-set multiplexer 470B can be coupled to calculation components of multiple filters (e.g., the first IIR filter 130 and the second IIR filter 180). Thus, in various implementations, multiple filters can utilize the coefficients through the coefficient-set multiplexer 470B.

The coefficient-set multiplexer 470B can provide flexibility by allowing the output, c_out, to be selected from two or more sets of coefficients. More specifically, the optional inputs for coefficient set A and coefficient set B can enable selection between different coefficient sets for different filter applications. In one implementation, the coefficient-set multiplexer 470B can be configured to cycle through a list of coefficients based on a counter signal provided by the counter 440B. In implementations requiring more dynamic control, such as adjustment of the coefficients based on conditions apart from timing, the coefficient-set multiplexer 470B can be controlled through use of an ALU or other logic circuitry.

As with FIG. 4A, when f_{clk} is greater than f_{sample,1}, the number of required calculation components (e.g., multiplier, adder, etc.) can be reduced by using the extra clock cycles of f_{clk} to control the selection and reuse of the calculation components. In the example of FIG. 1, the data rate of the signal to be processed is f_{sample,1}, and a maximum number of integer(f_{clk}/f_{sample,1}) operations can be processed sequentially before the next sample of the input signal is provided. In some implementations, the coefficient-set multiplexer 470B can require signaling to toggle the coefficient of one or more outputs, and, as such, the use of the coefficient-set multiplexer 470B can increase the number operations required for processing, and in turn, can increase the required ratio of f_{clk}/f_{sample,1}.

The schematic 400C of FIG. 4C illustrates an implementation of sequential operations allowing for a further reduction of required calculation components by directly coupling a coefficient multiplexer 470C to a calculation component. In particular, the schematic 400C replaces the multiplexer 458B by coupling the output of the coefficient multiplexer 470C to the multiplier 410C. This configuration enables a further trade off between a reduction of circuit components and use of extra clock cycles.

The coefficient multiplexer 470C has dynamic outputs, which can reflect one of multiple coefficients or sets of coefficients. Referring to the filtering process 100 of FIG. 1, the coefficient multiplexer 470C can be used to implement the coefficients 150 and/or coefficient selector 155. As such, outputs of the coefficient-set multiplexer 470C can be coupled to calculation components of multiple filters (e.g., the first IIR filter 130 and the second IIR filter 180). Thus, in various implementations, multiple filters can utilize the coefficients of the coefficient multiplexer 470C without requiring dedicated coefficients for each of the filters.

Also, the coefficient multiplexer 470C can provide flexibility by allowing the output, c_out, to be selected from two or more sets of coefficients. More specifically, the optional inputs for coefficient set A and coefficient set B can enable selection between different coefficient sets. In one implementation, the coefficient multiplexer 470C can be configured to cycle through a list of coefficients based on a counter signal provided by the counter 440C. In implementations requiring more dynamic control, such as adjustment of the coefficients based on conditions apart from timing, the coefficient multiplexer 470C can be controlled through use of an ALU or other logic circuitry.

As with FIGS. 4A and 4B, when f_{clk} is greater than f_{sample,1}, the number of required calculation components (e.g., multiplier, adder, etc.) can be reduced by using the extra clock cycles of f_{clk} to control the selection and reuse of the calculation components. In the example of FIG. 1, the sample rate of the signal to be processed is f_{sample,1}, and a maximum number of integer(f_{clk}/f_{sample,1}=R_{clk}) operations can be processed sequentially before the next sample of the input signal is provided. In some implementations, the coefficient multiplexer 470C can require signaling to toggle the coefficient of one or more outputs, and, as such, the use of the coefficient-set multiplexer 470B can increase the number of operations required for processing, and in turn, can increase the required ratio of f_{clk}/f_{sample,1}. In the implementation shown for FIG. 4C, the coefficient multiplexer 470C outputs a single output to the multiplier 410C and the multiplier 410C can be reused for multiple calculations.

FIG. 3B illustrates pseudo-code 300B for an IIR filter similar to the example implementation 400C of FIG. 4C. In particular, the pseudo-code 300B is configured to enable the switching of an output of a component (e.g., a coefficient selector 155 or 299B or a coefficient multiplexer 470C for each calculation). As can be seen by the pseudo-code 300B of FIG. 3B, this configuration requires a larger number of steps than the configuration of the pseudo-code 300A of FIG. 3A.

The above implementations of using the time sequential operation techniques to reduce circuit components for digital filtering processing are examples and the above described time sequential techniques are not limited to digital filter applications but can be applied to any digital processing, for example, a numeric mixer, a numeric LO, a digital synthesizer, or a decimation filter.

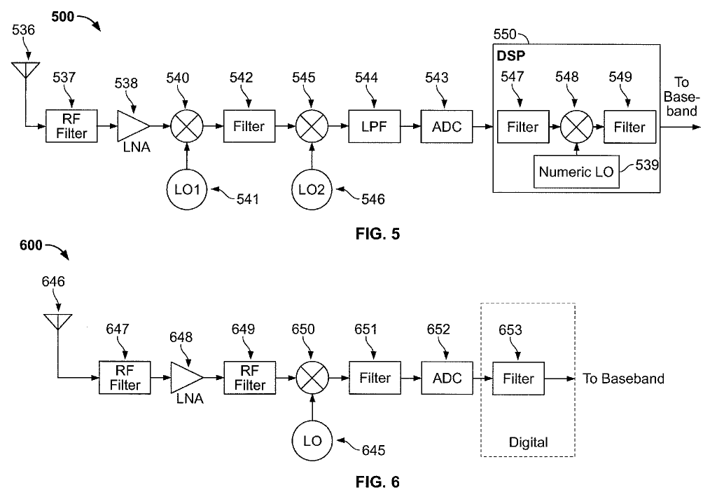

The disclosed techniques can be used with wireless communication systems. For example, the disclosed techniques can be used with receivers, transmitters, and transceivers, such as the receiver, transmitter, and/or transceiver architectures for superheterodyne receivers, image-rejection (e.g., Hartley, Weaver) receivers, zero-intermediate frequency (IF) receivers, low-IF receivers, direct-up transceivers, two-step up transceivers, and other types of receivers and transceivers for wireless and wireline technologies. FIGS. 5 and 6 are schematics demonstrating two examples of systems in which the IIR filtering techniques described above can be used to enable use of adjustable coefficients and/or reuse of calculation components. These techniques can also be used with signal processing techniques other than IIR filtering, such as in FIR filtering or in a numeric mixer.

In particular, FIG. 5 is a schematic of a low IF receiver 500. An RF signal arriving at an antenna 536 passes through an RF filter 537, a low noise amplifier (LNA) 538, and into a first mixer 540, which translates the RF signal down to an intermediate frequency by mixing it with the signal produced by a first LO 541. The signal then passes through an IF filter into a second mixer 545 to mix with a signal generated by a second LO 546. The output signal from the second mixer then passes through an anti-alias filter 544 before being converted to a digital signal by an ADC 543. The converted digital signal can then be processed by a dedicated digital signal processing unit 550 or as a part of a baseband processor comprised of circuit 100 as described in FIG. 1. In the digital domain, the signal is first passed through a decimator to decimate the received digital signal sampled at the rate f_{sample,in} to generate a decimated signal of data rate of f_{sample,1}. The decimated signal of data rate of f_{sample,1} then passes through a first digital filter 547 before entering a numeric mixer 548 to be mixed with a LO signal generated by a numeric LO 539. The signal then passes through a second filter 549. The signal is then sent to the baseband for further processing. The above described time sequential operation techniques can be used in the decimator filter, the mixer, the first and the second filters as well as the LO 539.

In another example, FIG. 6 is a schematic of a direct-conversion receiver 600. An antenna 646 couples a RF signal through a first bandpass RF filter 647 into an LNA 648. The signal then proceeds through a second RF filter 649, yielding a band-limited RF signal, which then enters a mixer 650 and mixes with an LO frequency produced by an LO 51. The mixer output is coupled into an anti-aliasing analog filter 651 before being converted to the digital domain by an ADC 652. In the digital domain, the signal can undergo further filtering 653 before proceeding into the baseband circuits.

The time sequential operation techniques described above can be applied to the digital signal processing functions in both the low IF and the direct conversion receivers. For example, the techniques can be used to reduce the area or increase the programmability of the decimator 535, the first digital filter 544, the numeric mixer 545, the LO 539 or the second digital filter 547 in the low IF receiver 500, or of the digital filter 653 in the direct-conversion receiver 600.

In some implementations, arithmetic elements such as registers, multiplier, adders, or other elements such as switches, capacitors, resistors, and inductors can be added, deleted, or exchanged from the disclosed figures with minimal change in circuit functionality. Various topologies for circuit models can also be used. The exemplary designs shown are not limited to any particular process technology, and can use various process technologies, such as CMOS or BiCMOS (Bipolar-CMOS) process technologies, or Silicon Germanium (SiGe) technology. The implementations can be single-ended or fully-differential circuits.

The system can include other components. Some of the components may include computers, processors, clocks, radios, signal generators, counters, test and measurement equipment, function generators, oscilloscopes, phase-locked loops, frequency synthesizers, phones, wireless communication devices, and components for the production and transmission of audio, video, and other data.

What is claimed is:

1. A method of performing digital filtering that includes filter arithmetic operations, the method comprising:
generating a system clock, the system clock having a rate of at least twice an input data rate; and
providing the system clock to a control circuit that controls at least one multiplier, at least one adder, and at least one storage element such that at least some of the filter arithmetic operations are performed time sequentially by the at least one multiplier, the at least one adder, and the at least one storage element before receiving a next input sample.

2. The method of claim 1 wherein the digital filtering is represented by the function:
$$y [ n ] = {\sum }_{i = 0}^{L} c [ i ] * x [ n - i ] + {\sum }_{j = 1}^{M} d [ j ] * y [ n - j ]$$
wherein x[n] is an array of sampled input signals; y[n] is an array of filter output signals; c is an array of input filter coefficients, d is an array of output filter coefficients; n is an input sampling number; and L and M are positive integers.

3. The method of claim 2 wherein at least some of the filter arithmetic operations that are performed time sequentially by the at lest one multiplier, the at lest one adder, and the at lest one storage element before receiving a next input sample include at least the following operations performed time sequentially:
(1) multiplying at least one delayed input sample by a first input filter coefficient to generate a first multiplication result, adding the first multiplication result to a first previously accumulated sum to generate a current accumulated sum; and storing the current accumulated sum;
(2) multiplying the current input sample by a second input filter coefficient to generate a second multiplication result; adding the second multiplication result to the current accumulated sum to generate an accumulated input sum, and storing the accumulated input sum;
(3) multiplying at least one delayed output sample by an output filter coefficient to generate a third multiplication result, adding the third multiplication result to a second previously accumulated sum to generate a current accumulated output sum, and storing the current accumulated output sum; and
(4) summing the accumulated input sum and the accumulated output sum to generate an output.

4. The method of claim 1 wherein the digital filtering implements an IIR filter.

5. The method of claim 1 wherein the digital filtering implements a FIR filter.

6. The method of claim 1 wherein the digital filtering includes feed-forward and feedback loops.

7. The method of claim 1 wherein an integer part of a ratio of the system clock to the input data rate is equal to or larger than a total number of the filter arithmetic operations that are performed time sequentially.

8. The method of claim 1 wherein the system clock is an analog-to-digital conversion sampling clock.

9. The method of claim 7 wherein a maximum number of the filter arithmetic operations that are performed time sequentially is limited to the integer part of the ratio of the system clock to the input data rate.

10. The method of claim 3 wherein values of the input and output filter coefficients are fixed or variable.

11. The method of claim 3 wherein the input and output filter coefficients are stored in a table or calculated dynamically.

12. The method of claim 3 wherein a filter coefficient selector selects the input and output filter coefficients.

13. The method of claim 12 wherein the filter coefficient selector is a counter, logic circuit, an arithmetic unit (ALU) or a programmable controller.

14. The method of claim 1 wherein the control circuit is configured to control two or more multipliers, two or more adders, two or more multiplexers, and at least one accumulator.

15. The method of claim of claim 3 wherein the input and output filter coefficients are time sequentially coupled to an input of the at least one multiplier.

16. The method of claim 3 wherein the current input sample, the delayed input sample and the delayed output sample are time sequentially coupled to an input of the at least one multiplier.

17. The method of claim 3 wherein the digital filtering is represented by:
$$y [ n ] = e * \{ {\sum }_{j = 0}^{2} d [ j ] {\sum }_{i = 0}^{3} c [ i ] * x [ n - i - j ] \} + {\sum }_{j = 1}^{2} g [ j ] {\sum }_{i = 0}^{3} c [ i ] * x [ n - i - j ] ,$$
wherein x[n] is an array of sampled input signals; y[n] is an array of filter output signals; e is a constant; c, d and g are arrays of filter coefficients, n is an input sampling number; and i and j are positive integers.

18. The method of claim 1 wherein the control circuit is configured to control the at least one multiplier, the at least one adder, and the at least one storage element such that at least one of the multiplier, the adder, or the storage element is reused for the filter arithmetic operations that are performed time sequentially.

19. A circuit implementing a digital filter, the circuit comprising:
a system clock generator configured to generate a system clock having a rate at least twice an input data rate;
at least one multiplier;
at least one adder;
at least one storage element; and
a control circuit configured to control the at lest one multiplier, the at lest one adder, and the at lest one storage element, wherein the system clock is coupled to the control circuit such that at least some of the filter arithmetic operations are performed time sequentially by the at least one multiplier, the at least one adder, and the at least one storage element before receiving a next input sample.

20. The circuit of claim 19 wherein the digital filter is represented by the function:
$$y [ n ] = {\sum }_{i = 0}^{L} c [ i ] * x [ n - i ] + {\sum }_{j = 1}^{M} d [ j ] * y [ n - j ] ,$$
wherein x[n] is an array of sampled input signals; y[n] is an array of filter output signals; c is an array of input filter coefficients, d is an array of output filter coefficients; n is an input sampling number; and L and M are positive integers.

21. The circuit of claim 20 wherein the system clock is coupled to the control circuit such that at least the following operations are performed time sequentially by the multiplier, the adder, and the storage element before receiving a next input sample:
(1) multiplying at least one delayed input sample by a first input filter coefficient to generate a first multiplication result, adding the first multiplication result to a first previously accumulated sum to generate a current accumulated sum; and storing the current accumulated sum;
(2) multiplying the current input sample by a second input filter coefficient to generate a second multiplication result; adding the second multiplication result to the current accumulated sum to generate an accumulated input sum, and storing the accumulated input sum;
(3) multiplying at least one delayed output sample by an output filter coefficient to generate a third multiplication result, adding the third multiplication result to a second previously accumulated sum to generate a current accumulated output sum, and storing the current accumulated output sum; and
(4) summing the accumulated input sum and the accumulated output sum to generate an output.

22. The circuit of claim 18 wherein the filter is an IIR filter.

23. The circuit of claim 18 wherein the filter is a FIR filter.

24. The circuit of claim 18 wherein the digital filter includes feed-forward and feedback loops.

25. The circuit of claim 18 further comprising two or more multipliers, two or more adders, three or more multiplexers and at least one accumulator.

26. The method of claim 18 wherein an integer part of a ratio of the system clock to the input data rate is equal to or larger than a total number of the filter arithmetic operations that are performed time sequentially.

27. The circuit of claim 18 wherein the system clock is an analog-to-digital conversion sampling clock.

28. The circuit of claim 26 wherein a maximum number of the filter arithmetic operations that are performed time sequentially is limited to the integer part of the ratio of the system clock to the input data rate.

29. The circuit of claim 20 wherein values of the input and output filter coefficients are fixed or variable.

30. The circuit of claim 20 wherein the input and output filter coefficients are stored in a table or calculated dynamically.

31. The circuit of claim 20 further comprising a filter coefficient selector to select the input and output filter coefficients.

32. The circuit of claim 31 wherein the filter coefficient selector is a counter, a logic circuit, an ALU or a programmable controller.

33. The circuit of claim 20 wherein the input and output filter coefficients are time sequentially coupled to an input of the at least one multiplier.

34. The circuit of claim 20 wherein the current input sample, the delayed input sample and the delayed output sample are time sequentially coupled to an input of the at least one multiplier.

35. The circuit of claim 19 wherein the filter is represented by:
$$y [ n ] = e * \{ {\sum }_{j = 0}^{2} d [ j ] {\sum }_{i = 0}^{3} c [ i ] * x [ n - i - j ] \} + {\sum }_{j = 1}^{2} g [ j ] {\sum }_{i = 0}^{3} c [ i ] * x [ n - i - j ] ,$$
wherein x[n] is an array of sampled input signals; y[n] is an array of filter output signals; e is a constant; c, d and g are arrays of filter coefficients, n is an input sampling number; and i and j are positive integers.

36. The circuit of claim 18 wherein the control circuit is configured to control the multiplier, the adder, and the storage element such that at least one of the multiplier, the adder, or the storage element is reused for the filter arithmetic operations that are performed time sequentially

37. A decimation and channel filtering system comprising:
a decimator configured to receive an input signal at a system clock rate and output a decimated signal on a decimator output, wherein the decimator is configured to output the decimated signal at a filter input data rate that is at least twice slower than the system clock rate;
a first programmable gain amplifier coupled to the decimator output;
a first filter coupled to an output of the first programmable gain amplifier, wherein the first filter is configured to perform at least some filter arithmetic operations time sequentially based on the system clock rate;
a second programmable gain amplifier coupled to an output of the first filter;
a numeric mixer coupled to an output of the second programmable gain amplifier;
a numeric local oscillator coupled to the numeric mixer;
a second filter coupled to an output of the numeric mixer, wherein the second filter is configured to perform at least some filter arithmetic operations time sequentially based on the system clock rate; and
a third programmable gain amplifier coupled to an output of the second filter.

38. The system of claim 37 wherein the numeric local oscillator is configured to perform at least some oscillator arithmetic operations time sequentially based on the system clock rate.

39. The system of claim 37 further comprising a filter coefficient selector configured to select a filter coefficient of an array of filter coefficients for the filter arithmetic operations of the first or second filter.

40. The system of claim 37 wherein the first or second filter comprises an IIR filter.

41. The system of claim 37 wherein the first or the second filter includes forward and feedback loops.

42. The system of claim 37 wherein the first or second filter includes calculation components, storage elements, delay elements, and multiplexers.

43. The system of claim 39 wherein the array of filter coefficients include decimation filter coefficients, the filter input coefficients, delayed filter input coefficients, and delayed filter output coefficients.

44. The system of claim 39 wherein a maximum number of filter arithmetic operations performed time sequentially by the first and the second filter is limited to an integer part of a ratio of the system clock to the filter input data rate.

45. The system of claim 39 wherein the decimation filter, the mixer, the first filter, and the second filter are configured to reuse components.

46. A receiver comprising:
a radio frequency (RF) input signal received by an antenna coupled to an RF filter;
an low noise amplifier (LNA) coupled to an output of the RF filter;
a first set of I/Q mixers configured to perform image rejection and mix an output of the LNA with a first set of quadrature I/Q output signals tuned by a first frequency divider from an output of a first local oscillator;
a set of I/Q intermediate frequency (IF) filters coupled to a first set of mixed I/Q outputs of the first set of I/Q mixers;
a second set of I/Q mixers configured to mix filtered I/Q outputs of the I/Q intermediate filer (IF) filters with a second set of I/Q outputs generated and tuned by a second frequency divider from an output of a second local oscillator;
an analog-to-digital converter coupled to a second set of mixed I/Q outputs and configured to produce a digital signal sampled at a system clock;
a digital-signal-processing unit including a decimator configured to receive the digital signal and generate a decimated output at a data rate slower than the system clock, a first filter, a mixer, a third local oscillator, and a second filter, wherein at least one of the decimator, the first filter, the mixer, the third local oscillator, or the second filter is configured to perform at least some arithmetic operations time sequentially based on the system clock rate; and
a baseband processing circuit configured to receive an output from the digital-signal-processing unit.

47. The receiver of claim 46 further comprising a filter coefficient selector to select filter coefficients.

48. The receiver of claim 46 wherein the filter coefficient selector is a counter, a logic circuit, an ALU or a programmable controller.

49. The receiver of claim 46 wherein each of the decimator, the first filter, the mixer, the third local oscillator, or the second filter are configured to perform at least some arithmetic operations time sequentially based on the system clock rate.

50. The receiver of claim 46 wherein a maximum total number of arithmetic operations performed sequentially by the decimator, the first filter, the mixer, the third local oscillator, and the second filter, either individually or in combination, is limited to an integer part of a ratio of the system clock to a data rate that is slower than the system clock.
